(19) United States
(12) Patent Application Publication
(10) Pub. No.: US 2009/0106606 A1
(43) Pub. Date: Apr. 23, 2009

(54) METHOD AND APPARATUS FOR DETECTING AND ISOLATING CONTROLLER AREA NETWORK PERMANENT DOMINANT STATES

(75) Inventors: Huihui Duan, New Bedford, MA (US); Gregory A. Jean-Baptiste, Fort Wayne, IN (US); Francisco Gutierrez, Chicago, IL (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/873,466

(22) Filed: Oct. 17, 2007

(51) Int. Cl. G06F 11/30

(52) U.S. Cl. 714/48; 714/E11.179

(57) ABSTRACT

Detection of a permanent dominant state on a Controller Area Network node, occurring nearly simultaneously with development of the state, is used to the node from the network. Detection is independent of the application environment.

### BACKGROUND OF THE INVENTION

1. Technical Field

The invention relates to fault monitoring for and isolation of a node on a controller area network and more particularly to a method and system for disabling the node when the node is in a condition which would result in a network permanent dominant state.

2. Description of the Problem

Controller area networks (CAN) have rapidly become established on motor vehicles as a flexible control system which can readily accommodate changes in vehicle equipment without redesign of the physical hardware of the vehicle control system. They also greatly simplify control system layouts and allow some degree of integration in the control of formerly independent systems. CAN nodes have been applied to the control of engines, transmissions, anti-lock brake systems (ABS) on trucks and buses.

Each node on a CAN is able to transmit and receive messages over the network's physical layer or “bus”. In motor vehicle applications this is typically a twisted pair cable. When a CAN node transceiver's Transmit Data (TXD) pin is forced permanently low by any hardware and/or software application failure (or by a ground fault), the low state on the pin drives the whole CAN bus into a permanent dominant state. The permanent dominant state blocks all network communication. To keep the rest of network operating, a node which has caused to permanent dominant state to arise should be detected and isolated from the network as soon as possible.

In some prior art CAN systems the possibility of an occurrence of a permanent dominate state was simply not dealt with. The circuit schematic of FIG. 3 is for a prior art CAN node transceiver without the means to handle the occasion of a permanent dominate state originating with the node. The transceiver 300 is a conventional device for use with a two wire bus with high and low lines. A reference voltage source 314 is available. Receive pins (RXD) and transmit pins (TXD) supply bit streams to and receive bit streams from data processing units or protocol engines. The receive pin value is controlled by a receiver/differential amplifier 312 the inputs to which are directly connectable to the high and low channels of a CAN bus. Transceiver 300 includes a buffer 304 receiving data on the transmit pin. The buffer is connected to a driver 302 which provides base signals to the base of PNP drive transistor 310 and to the base of NPN drive transistor 320 corresponding to the formatted message. PNP transistor is connected by its emitter to the voltage supply V_{CC} and at its collector by diode 316 to the high channel of the CAN twisted pair datalink. The low channel of the CAN datalink is connected by diode 318 to the collector of NPN transistor 320. The emitter of the NPN transistor 320 is connected to ground. Driver 302 is provided with temperature protection 308. If a permanently low (ground fault) occurs on the TXD (transmit) pin, it acts to hold a CAN network to a Dominant State, and no message can be transferred. A fault corresponding to the node in which this transceiver is located results in a permanent dominant state and disabling of the CAN in which the node is located.

A prior art CAN transceiver adapted to handle a node fault is illustrated in the circuit schematic of FIG. 4. The circuit layout is somewhat different than FIG. 3, though all of the functions of FIG. 3 are fully realized. FET transistors 426, 428 are controlled by gate signals from a driver 420 and connect the high and low lines of the CAN bus to a voltage source V_{CC} or ground (with diode 426, 430) drops. Signals received over the CAN bus are provided with preliminary amplification via differential amplifiers 434, 436, with the output of amplifier 434 being applied to a filter 422 and to a mode control unit 410. The outputs of the mode control unit 410 and the amplified message output of amplifier 436 are supplied to a multiplexor (MUX) 424 which controls the receive pin. Wake-up/mode control unit 410 also enables the time-out/slope unit 402 which receives incoming signals on the transmit pin. Here, if the duration of the LOW level on the transmit pin TXD exceeds the internal timer 402 value (which may vary from 300 microseconds to 4 milli-seconds), the transmitter is disabled, driving the bus lines into a recessive state. The timer is reset by a positive edge on pin TXD. A byproduct of this design is that the time out period typically defines the minimum possible bit rate for the network, typically a minimum bit rate of 40 k Baud. There are other limitations in this design. The duration of the timer will change chip by chip, and is affected by the environment. The delay will disturb communication over the network. For the highest speed applications, such as SAE J1939 (250 k Baud), a time delay up to 4 milli-seconds means more than 1000 bits information (about seven CAN extended frame messages) of bus capacity is lost. With increasing bus speed more and more band width will be lost. The value of quick identification of a fault will be greater for TTP/C (Time-Triggered Protocol, Class C, up to 500 k Baud rate when using CAN transceiver) and Time-Triggered CAN (up to 1 M Baud rate, which will be used for X-by-Wire application).

### SUMMARY OF THE INVENTION

According to the invention there is provided a system and method for detection of a permanent dominant state on a CAN which occurs essentially simultaneously with occurrence of the state. The system and method of the invention further provides for isolation the node on the CAN giving rise to the permanent dominant state.

In the preferred embodiment of the invention a node on a CAN network includes a CAN transceiver, a CAN protocol engine, a CAN clock circuit, a interruptible connector from the CAN protocol engine and the CAN transceiver and a monitor and judging circuit. The CAN clock circuit generates an accurate CAN clock signal used to drive the monitor circuit. The monitor circuit monitors the CAN transmit (TXD) output of the CAN protocol engine. If more than 12 consecutive transmitted dominant bits occur, the monitor circuit will interrupt a connection between the CAN transceiver and the CAN protocol engine immediately. The remainder of the network can continue operating without the interrupted node. When the system ground fault problem is resolved, indicated as the moment the CAN protocol engine outputs a recessive bit on the CAN TXD line, the monitor circuit will re-enable the connection between the CAN transceiver and the CAN protocol engine and restore the node's position on the CAN. The invention can be implemented in both discrete elements level and Large-Scale-Integrated (LSI) Integrated Circuit level. The invention can be implemented in each node of a CAN network, just those nodes unusually subject to faults, or just with nodes not critical to vehicle operation. While control strategies may be inferred herein, a particular, optimal control strategy for a given application is beyond the scope of the invention.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a schematic illustration of a controller area network on a tractor/trailer environment in which the present invention is advantageously applied.

FIG. 2 is a block diagram of a motor vehicle controller area network.

FIG. 3 is a mixed circuit schematic and block diagram of a prior art controller area network transceiver.

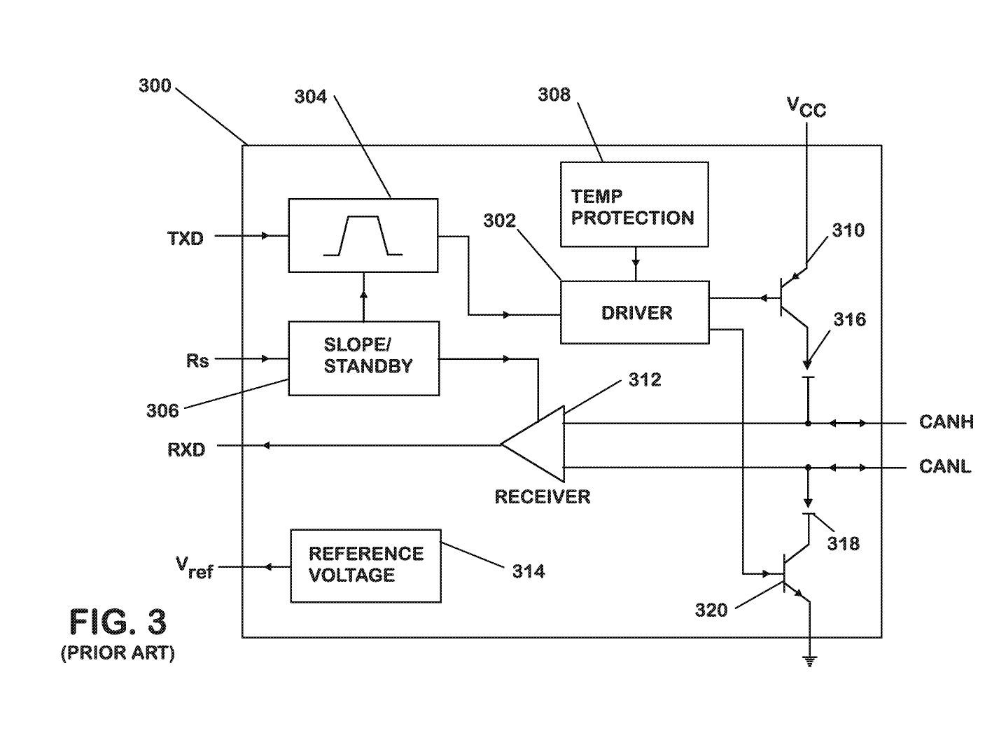

FIG. 4 is a mixed circuit schematic and block diagram of a prior art transceiver providing time out detection of a node fault.

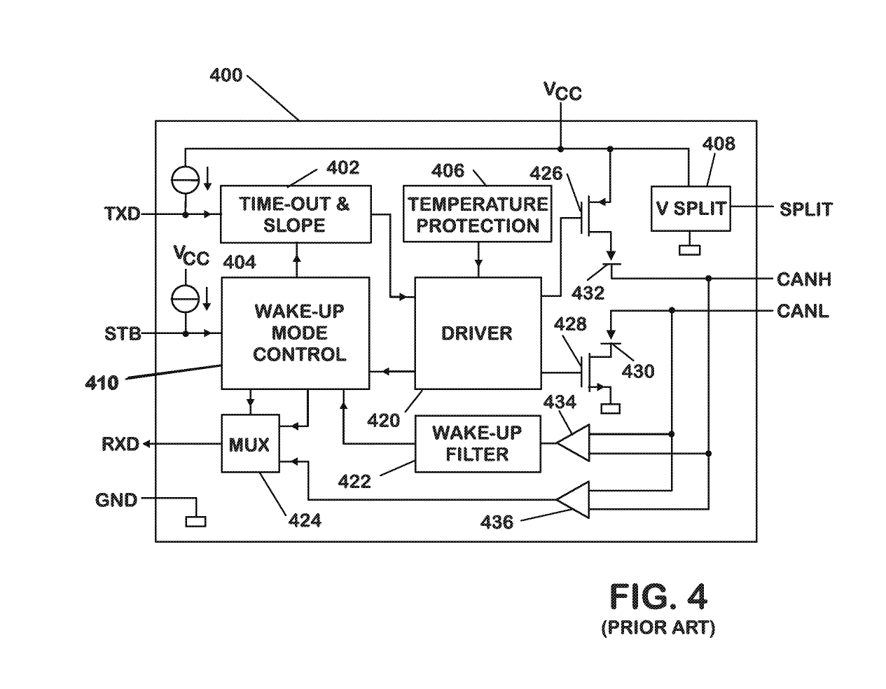

FIG. 5 is a block diagram of selected nodes for a motor vehicle controller area network incorporating the present invention.

FIGS. 6A-B are circuit schematics for timing clocks usable with the present invention.

FIG. 7 is a logic diagram of a multi-stage latch circuit for detecting chains of identically valued output bits.

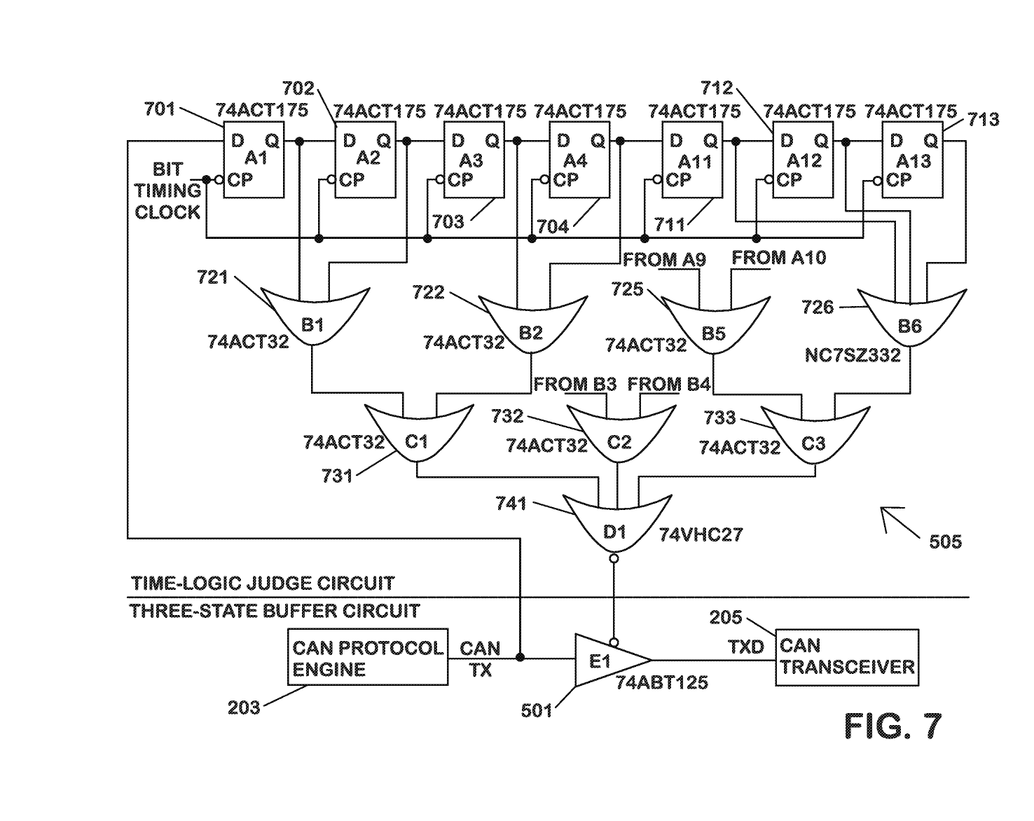

### DETAILED DESCRIPTION OF THE INVENTION

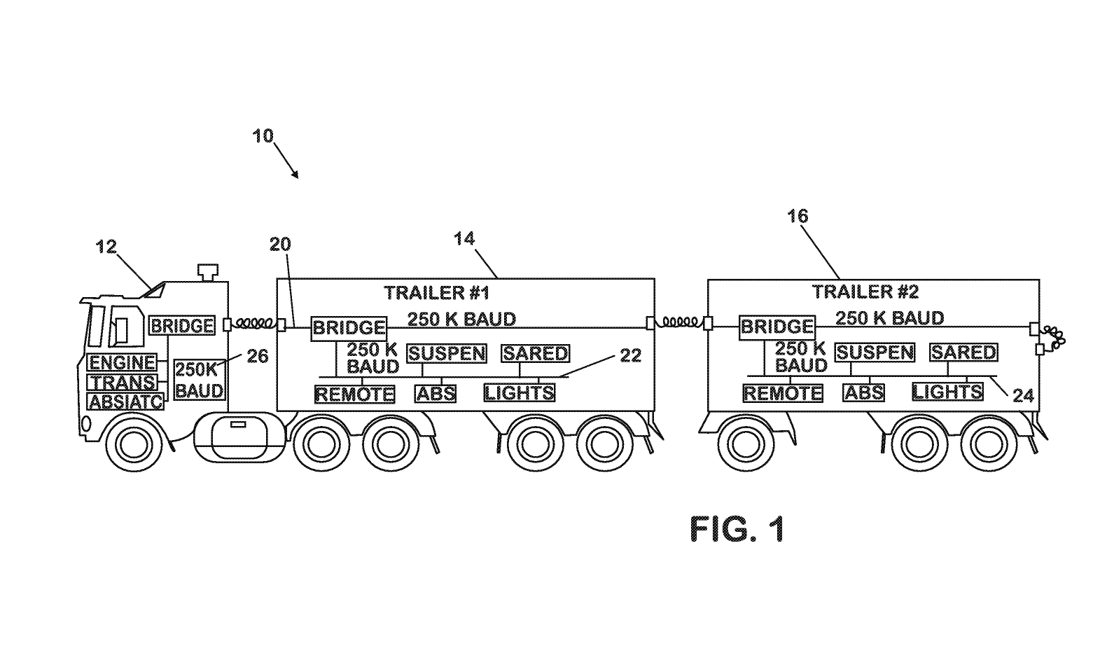

Referring now to the figures and in particular to FIG. 1, a generalized vehicle comprising a tractor 12 and trailers 14, 16, each of which includes a controller area network (CAN) 26, 22, 24, are shown. CAN's 26, 22, 24 may be interlinked by appropriate cabling and bridges, though the inclusion of such is not necessary for operation of the invention. The CAN's 26, 22, 24 will generally comply with the SAE J1939 standard for controller area networks installed on motor vehicles.

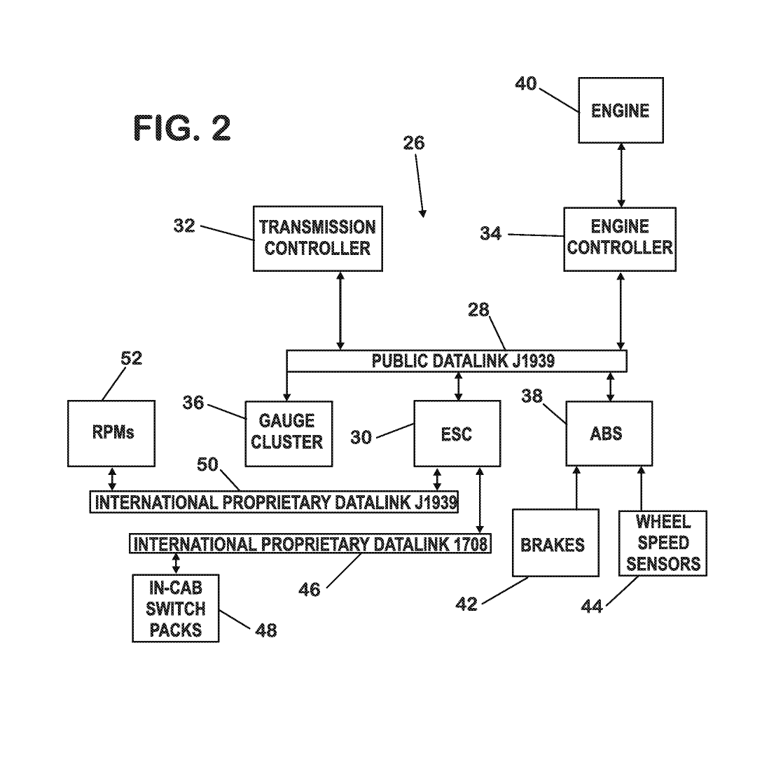

Referring to FIG. 2, a high level schematic of controller area network 26 from tractor 12 is illustrated. An electrical system controller 30, a type of a body computer, is linked by a public datalink 28 to a variety of local controllers which in turn implement direct control over most tractor 12 functions. Electrical system controller (ESC) 30 may also be directly connected to selected inputs and outputs (not shown), to in-cab switch packs 48 using a SAE J1708 compliant datalink 46 and to remote power modules 52 using a proprietary J1939 compliant datalink 50. However, the preferred application of the present invention is with controllers connected to the public datalink 28. These controllers are the nodes of a controller area network.

Four major local controllers, in addition to the ESC 30, are illustrated as connected to the public datalink 28. These controllers are the engine controller 34, the transmission controller 32, a gauge controller 36 and an anti-lock brake system controller (ABS or brake controller) 38. Datalink 18 is preferably the bus for a public controller area network (CAN) conforming to the SAE J1939 standard and under current practice supports data transmission at 250 Kbaud, though the invention anticipates the need to meet higher data rates in the future. It will be understood that other controllers may be installed on the vehicle coupled to datalink 18. ABS controller 38, as is conventional, controls application of brakes 42 and receives wheel speed sensor signals from sensors 44. Engine 40 includes sensors monitored by engine controller 34 and may be taken to include ancillary equipment such as fuel injectors under the control of the engine controller 34. Similarly, the gauge controller 36 may be used to control information displays to a vehicle operator.

The various controllers exchange data over datalink 28. An exhaustive description of the character of that data is unnecessary for understanding of the invention. An example of such data illustrating cooperation among controllers would be the transmission of engine tachometer data and vehicle speed data, reported by the engine controller 34 and ABS controller 38 respectively, to be read by the transmission controller 32 and to be used to select a vehicle operating gear. The transmission controller may be programmed to operate in the absence of some data. When it is said that data is read by a controller it should be understood that messages on a controller area network are not generally addressed to a particular node, but rather are broadcast over the datalink 28, and individual controllers are programmed to recognize the source and character of the data, and to operate on the date if necessary for the given controllers operation.

Controllers, each of which constitutes a node on CAN 26, are subject, like any piece of programmed computing hardware, to physical and software problems. These problems can give rise to what is termed a permanent dominant state, potentially rendering the network inoperable.

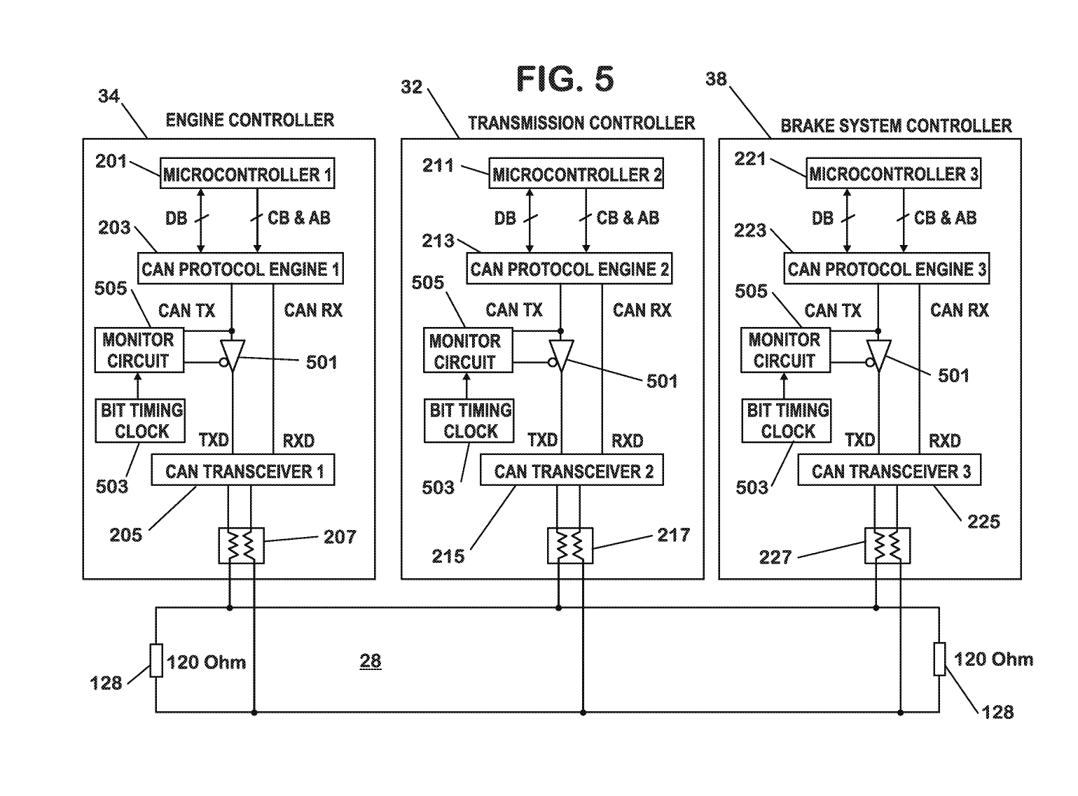

Referring now to FIG. 5, nodes 34, 32, 38 of a controller area network 28 have been modified to detect the occasion of a permanent dominant state originating on the same node and to isolate the node from the remainder of the network. Nodes 34, 32, 38 correspond to engine controller 34, transmission controller 32 and brake system (or ABS) controller 38. While in theory the electrical system controller (ESC) 30 could also be modified to isolate it in case of a fault, its operation is so central to control of the vehicle that were it inoperable the vehicle would be rendered inoperable. Hence the system controller (ESC) 30 is not illustrated as including the modifications made to the engine, brake system and transmission controllers 34, 32, 38. The layout of each of controller 34, 32, 38 is more or less the same, being based on a microcontroller 201, 211, 221, though in practice the capabilities of each controller will differ greatly. All data relating to a given controller 34, 32, 38 eventually passes through a microcontroller for operations. Such data must be encoded or decoded for CAN transmission, which is handled by one of CAN protocol engines 203, 213, 223. CAN transceiver units 207, 217, 227 are located between the protocol engines 203, 213, 223 and are connected by plug attachments 207, 217, 227 to the bus.

Considering the engine controller 34 as representative of all of the controllers modified to implement the invention, the system of the present invention provides for monitoring the output of the CAN protocol engine 203, or, put another way, the input on the transmit pin of the CAN transceiver 205. Three major operative components are used to implement the preferred embodiment of the invention. Among these components are an accurate CAN bit timing clock 503, the output of which clocks a monitor circuit 505. Monitor circuit 505 is attached to receive the protocol engine 203 CAN TX output. If more than 12 consecutive dominant bits are output by the protocol engine 203, the monitor circuit 505 will disconnect a connection 501 between the CAN transceiver 205 and the CAN protocol engine 203. In network terms this is effective immediately. When the system ground fault problem is solved, indicated as the moment the CAN protocol engine TXD is a recessive bit, the monitor circuit 505 re-enables the connection 501 between the CAN transceiver 205 and the CAN protocol engine 203. The circuitry can be implemented in both discrete elements level and Large-Scale-Integrated (LSI) Integrated Circuit level.

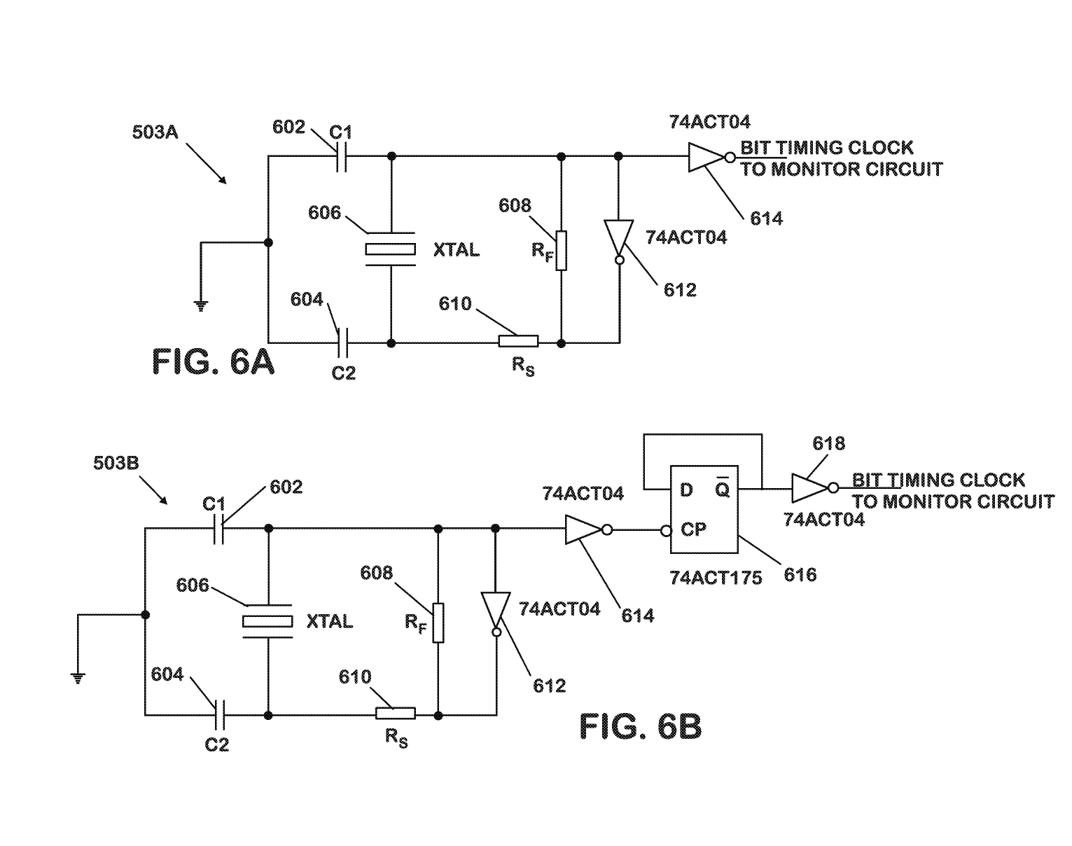

The bit timing clock 502 generates a clock which has the same frequency as the frequency that the CAN bus operates on. If bus traffic is sufficiently high a phased lock loop application could be used to recover the clock from bus traffic, though the present invention isolates generation of the clock from the bus. The generated clock drives the timing logic circuit of the monitor circuit 505. More usually though one of the two clock circuits of FIGS. 6A-B are used. The clock circuits are conventional RC crystal 606 oscillators modified to provide a pulse train output. The RC networks include capacitors 602, 604 and resistors 608, 610. An amplifier 612 is a feedback element. Amplifier 614 provides a square wave output. In the circuit of FIG. 6B the output of amplifier 614 is attached to the clock input of a D-type flip-flop 616 to provide frequency division exploiting the toggling capability of the flip-flop in conventional fashion by feeding the Q′ output back to the Data input. An amplifier 618 takes the output of the flip-flop 616.

The Monitor Circuit 505 consists of a timed-logic judge circuit and operates with a three-state buffer circuit including the CAN protocol engine 203, connection 501 and CAN transceiver 205. The timed logic judge/monitor circuit 505 is driven by the bit timing clock and records the TXD bit status from the CAN protocol engine 203 for the present and 12 previous clock cycles. Those skilled in the art will now realize that the number consecutive bit status states judged will depend upon specific applications, for example whether 12 consecutive high bit status signals are possible, whether the system can allow isolation of a node based only on a high probability of a fault, and how important it is to detect and isolate a potentially faulty node quickly.

The timed-logic judge/monitor circuit 505 comprises essentially two major sub-systems, the first being a shift register storing the present and previous 12 states of the TXD bit status line and an array of logical OR gates which generate a high logic output when all 13 cells of the shift register are concurrently low. The high logic output from the array of OR gates turns the connection control element 501 to a high impedance state interrupting the flow of data from the CAN protocol engine 203 to the CAN transceiver 205. This effects disconnection of the ground fault node from the rest of the network. This state remains only until the flow of low bits from the CAN protocol 203 is interrupted by a high bit. The logic array could in theory be designed to detect any particular bit pattern in the sequence of states of the transmit output of the protocol engine 203, however in the preferred embodiment the interest is only in when the protocol engine locks on generating dominant bits each clock cycle.

The shift register is constructed in the preferred embodiment from 13 serially connected D-type flip-flops 701-713 (not all shown). The Q outputs from each of flip-flops 701-713 are supplied to 6 parallel OR gates 721-726 (OR gates 724 and 725 not shown). OR gate 721 takes the outputs of flip-flops 701, 702. OR gate 722 takes the outputs of flip-flops 703, 704. OR gate 723 (not shown) takes the outputs of flip-flops 705, 706 (not shown). OR gate 724 (not shown) takes the outputs of flip-flops 707, 708 (not shown). OR gate 725 takes the outputs of flip-flops 709, 710 (not shown). Three input OR gate 726 takes the outputs of flip-flops 711, 712 and 713. A second stage of comparisons is done using OR gates 731, 732, 733, which compare the outputs of OR gates 721-726. Finally, a third stage OR gate 741 compares the outputs of OR gates 731, 732, 733. Those skilled in the art will realize that were a 13 input OR gate available there would be no need for three stages of logic comparison, the purpose of the array of OR gates being simply to detect the existence of one divergent bit state to avoid disabling the three state buffer circuit. Were the dominant state “high” such a gate could be constructed from 13 parallel diodes. It will be understood that conceptually the present invention, with appropriate modification, can work with either logic high or logic low, and that the term dominant and recessive should not be limited to being one or the other of “high” or “low”.

The delay of the three-state buffer and control logic gates are in the nanoseconds level. Compared with the CAN bit rate, which is in the milliseconds level, the time delay of logic gates and three-state buffer circuit is negligible.

The invention provides for monitoring the CAN protocol engine's CAN TXD input with accurate CAN bit timing clock, using an environment-independent circuit generate CAN bit timing clock. The CAN bit timing clock can be changed for CAN system running at different speed. It provides for detection and isolation of the Permanent Dominant Fault within at most a few clock cycles of its occurrence. In some embodiments it may be preferred to integrate the clock generation circuit and monitor circuit with the CAN Transceiver and it may be used with various controllers, such as a cab or chassis controller. The use of the circuit with one controller on a network does not dictate use with other controllers.

Because a bit-timing clock is used the time to detect and isolate a ground-fault node will be the shortest time possible (12 bits time, which is allowed by CAN). This feature is important for a high-speed CAN network. In the case of J1939 network, the 12-bits time delay will be 48 microseconds, which is much less than current CAN transceiver designs. In the case of a low speed CAN network, for instance, a 40 K Baud rate CAN system, the time delay will be 300 microseconds, which is better or equal to the best performance of current CAN transceiver designs. The detection and isolation of a Permanent Dominant state is environment independent since the clock is isolated from the bus. There is no minimum limited speed to the network. The invention will meet the transceiver requirements for next generation vehicle safety-critical network system, such as: x-by-wire system.

While the invention is shown in only one of its forms, it is not thus limited but is susceptible to various changes and modifications without departing from the spirit and scope of the invention.

What is claimed is:

1. A controller area network node comprises:
a controller area network protocol engine having a transmit output assuming dominant and recessive states;
a controller area network transceiver having a transmit input for receiving the transmit output;
a clock;
a shift register connected to be clocked by the clock and further connected to the transmit output for storing uninterrupted sequences of states of the transmit output; and
a logic array coupled to the shift register for comparing the states stored thereon for a specific pattern among the stored uninterrupted sequences of states indicative of a node fault.

2. A controller area network node in accordance with claim 1, further comprising:
an interruptible connection between the transmit output and the transmit input;
an output from the logic array connected to the interruptible connection, the interruptible connection being responsive to the output from interrupting the interruptible connection between the transmit output and the transmit input.

3. A controller area network node in accordance with claim 2, further comprising:
the specific pattern corresponding to the dominant state repeating on the transmit output in an uninterrupted sequence for a predetermined minimum number of clock cycles.

4. A controller area network node in accordance with claim 3, wherein the controller area network node is a controller in a vehicular application.

5. A controller area network comprising:
a bus;
a plurality of nodes each including a protocol engine and a transceiver, the protocol engines being coupled to the transceivers to supply data for transmission over the bus and the transceivers being connected to the bus;
at least a first node potentially subject to faults leading to a permanent dominant state on the bus; and
the first node including an interruptible connector between the protocol engine and the transceiver of the first node, the interruptible connector being responsive to a monitor and judging circuit connected to the output of the protocol engine for controlling connection of the protocol engine to the transceiver.

6. A controller area network in accordance with claim 5, said at least first node further comprising:
a network independent clock generating a clock signal with the same frequency as a bus operating frequency.

7. A controller area network in accordance with claim 6, said at least first node further comprising:
the having a transmit output assuming dominant and recessive states;
the transceiver having a transmit input for receiving the transmit output;
a shift register connected to be clocked by the clock and further connected to the transmit output for storing uninterrupted sequences of states of the transmit output; and
a logic array coupled to the shift register for comparing the states stored thereon for a specific pattern among the stored uninterrupted sequences of states indicative of a fault on said first node.

8. A controller area network in accordance with claim 7, further comprising:
an output from the logic array connected to the interruptible connection, the interruptible connection being responsive to the output from interrupting the interruptible connection between the transmit output and the transmit input.

9. A controller area network in accordance with claim 7, further comprising:
the specific pattern corresponding to the dominant state repeating on the transmit output in an uninterrupted sequence for a predetermined minimum number of clock cycles.

10. A controller area network in accordance with claim 8, wherein the controller area network is installed in a vehicular application.

11. A method of isolating at least one of a plurality of nodes connected for communication over controller area network, the method comprising the steps of:
providing each node with a protocol engine and a transceiver, the protocol engines being coupled to the transceivers to supply data for transmission over the bus by the transceivers;
providing an interruptible connection between the protocol engine and the transceiver of each node subject to interruption due to faults;
monitoring the output of the protocol engine for disallowed outputs; and
responsive to occurrence of a disallowed output interrupting the interruptible connection between the protocol engine associated with the disallowed output and its respective transceiver.

12. The method in accordance with claim 11, comprising the further step of supplying nodes with a network independent clock generating a clock signal of the same frequency as a bus operating frequency.
